(19) United States
(12) Patent Application Publication
(10) Pub. No.: US 2016/0148452 A1
(43) Pub. Date: May 26, 2016

(54) SYSTEM FOR SECURELY TRANSPORTING AND HOUSING COSMETICS

(71) Applicant: ANTONIO DANIEL TORQUEMADA JIMÉNEZ, Campo Real (ES)

(72) Inventor: ANTONIO DANIEL TORQUEMADA JIMÉNEZ, Campo Real (ES)

(21) Appl. No.: 14/637,002

(22) Filed: Mar. 3, 2015

(30) Foreign Application Priority Data
Nov. 24, 2014 (ES) P201431733

(51) Int. Cl. G07C 9/00; B65D 33/25; B65D 43/00; A45D 40/24

(52) U.S. Cl. CPC G07C 9/00158; A45D 40/24; B65D 33/25; B65D 43/00

(57) ABSTRACT

A system comprising:
a container or box (1) provided with means for accessing the inside and means for opening and closing (3) the container or box (1)
a smartphone (12) that may send and receive information to and from the container or box (1).

Where the opening and closing means (3) are based on the use of biometric sensors for reading fingerprints and the smartphone enables the registering and de-registering of users to be controlled and remote opening and closing to be carried out. Furthermore, it comprises an electromechanical lock (4), electronic control (5) for opening and closing, signalling means of the operations carried out, which may be lights (7) or acoustic means such as a buzzer (8) and an opening and closing detection sensor (9). The secure transport and housing of products, and access by several users without needing to use keys or similar, with the possibility of configuring the activation or de-activation of the electronic register of opening and alarm events, is achieved.

### OBJECT OF THE INVENTION

The object of the present invention is, as established in the invention title, a system for securely transporting and housing cosmetics that seeks to avoid the theft of the cosmetics housed in a box at home or in hotels. The system comprises a box, where products such as cosmetics and similar may be housed and transported, and a smartphone that enables users to be registered and de-registered and even opening remotely at close range.

The present invention is characterised by the special technical features of the elements that form part of the system in such a way that, in combination and acting synergistically, they give rise to an effective, simple security system that is easy to handle and build.

Therefore, the present invention falls within the field of secure closing systems, as well as within the field of packaging used for transporting cosmetics and similar.

### BACKGROUND OF THE INVENTION

There are safes known in the state of the art that have one security compartment that have been conceived so that they are very difficult for unauthorised people to open and thus be able to keep objects of value.

In general, they are made of an extremely resistant metal; they tend to be very heavy and consist of a closing system that may only be opened via secret codes, and these codes may be changed in order to further maintain security. A less secure version (only suitable for petty cash) is called a money safe.

In other cases, when security on suitcases and other accessories is required, closures with keys are provided, either via padlocks or closures with a mechanical combination code. Although they are systems that fulfil the purpose sought, they have drawbacks that could be improved, such as for example, the fact that a key must be connected in order to be able to open the suitcase or container; the long period of time required to carry out the opening and closing operation; and requiring actions in the closing element in order for closure to be carried out. Moreover, the opening of the box would be restricted to the key holders, which may only be just one person, with the inconveniences that this entails. Furthermore, there is a certain risk of losing the key and in the case of the combination code there is the risk of the code being obtained as a result of repeated combination attempts (given the small number of possible combinations).

Therefore, the object of the present invention is to develop a system for securely transporting and housing products such as cosmetics, which overcomes the aforementioned drawbacks, thus developing a system such as the one described below and the essential nature of which is reflected in the first claim.

### DESCRIPTION OF THE INVENTION

The object of the present invention is a system for securely housing and transporting cosmetics that is characterised in that it comprises a cosmetics container or box in which the cosmetics or products to protect are housed, and a smartphone.

The cosmetics container or box is a box made out of high-resistance insulating material equipped with a mechanism for accessing the inside, and opening and closing means.

The means for accessing the inside in the rigid case embodiment is a hinged lid and in the flexible bag embodiment it is a zip.

The opening and closing means comprise:
An electromechanical lock
An electronic control for opening and closing
User identification means via fingerprints
At least one opening and closing detection sensor
A mechanical mechanism that enables automatic locking by merely closing the box without requiring any additional action
An electronic registering mechanism of opening and alarm events
External communication means, for example via electromagnetic signals or via Bluetooth.
Power supply means, which is preferably via batteries or cells
Indication means of the operations carried out, said indication means potentially being via a light or acoustic signal.

With the aim of improving the state of the products housed inside the container or box, in a manner that is complementary to the system, the container or box may in particular be provided with cooling means, preferably carried out via thermoelectric cooling that uses the Peltier effect to create a thermal flow through the joining of two different materials, such as metals or P- and N-type semiconductors, with the aim of controlling the inside temperature of the box and preventing the temperature from rising above a programmable threshold.

The smartphone is equipped with an application that enables opening and closing remotely at close range, as well as being able to register and de-register users, and an alarm configuration based on the inside temperature of the container or box, and configuring the electronic opening and alarm register, and reviewing the events registered (in the event that the storage thereof has been configured).

Due to the features that the system is equipped with and the collective and interactive arrangement thereof, a variety of effects are achieved simultaneously: on the one hand, the secure transport and housing of products, such as cosmetics and similar, where the free availability thereof is not reduced to a single user, but rather several users may be registered, where in addition the opening and closing is not carried out on the basis of keys, but rather depending on the user's fingerprints, remote opening and closing being possible.

Throughout the description and the claims, the word “comprises” and variants thereof are not intended to exclude other technical features, additions, components or steps. For those skilled in the art, other objects, advantages and features of the invention may be deduced from both the description and the practical use of the invention.

### BRIEF DESCRIPTION OF THE DRAWINGS

As a complement to the present description, and for the purpose of helping to make the characteristics of the invention more readily understandable, in accordance with a preferred practical exemplary embodiment thereof, said description is accompanied by a set of drawings constituting an integral part of the same, which by way of illustration and not limitation represent the following.

In FIG. 1, a general representation of the system for transporting and housing cosmetics, object of the invention, may be seen.

In FIG. 2, a possible embodiment of the opening and closing element may be seen in a simplified manner, where the different elements that provide the different features may be seen.

FIG. 3 shows a possible embodiment in which the container or box is a rigid case.

FIG. 4 shows the container of FIG. 3 which is partially open in order to appreciate the interior.

FIG. 5 shows a possible embodiment in which the container or box is a flexible bag that is accessed by means of a zip. FIG. 6 shows a detail of one of the zip.

### PREFERRED EMBODIMENT OF THE INVENTION

With reference to the figures, a preferred embodiment of the invention proposed is described below.

In FIG. 1 it may be seen that the system for transporting and housing cosmetics and similar comprises:
a container or box (1) provided with means for accessing the inside, which in the case represented is a hinged lid (2), and means for opening and closing (3) the container or box (1)
a smartphone (12) that may send and receive information to and from the container or box (1).

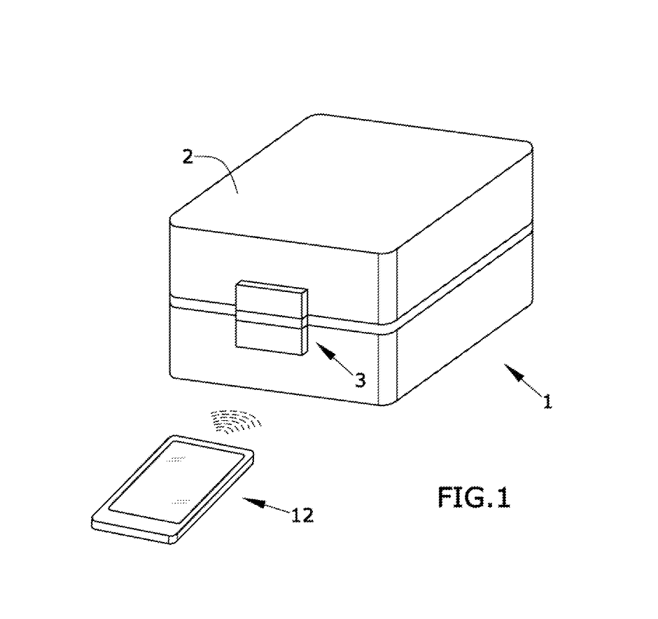

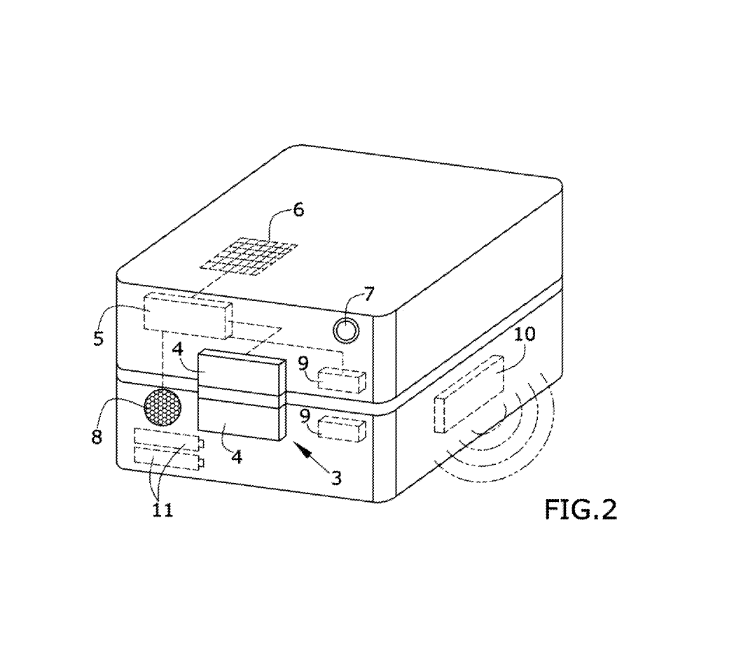

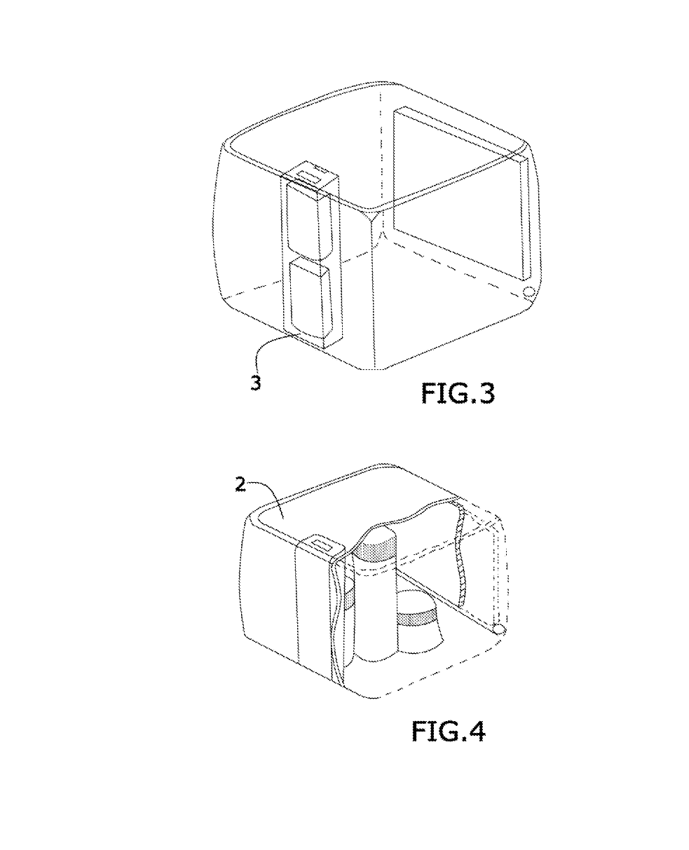

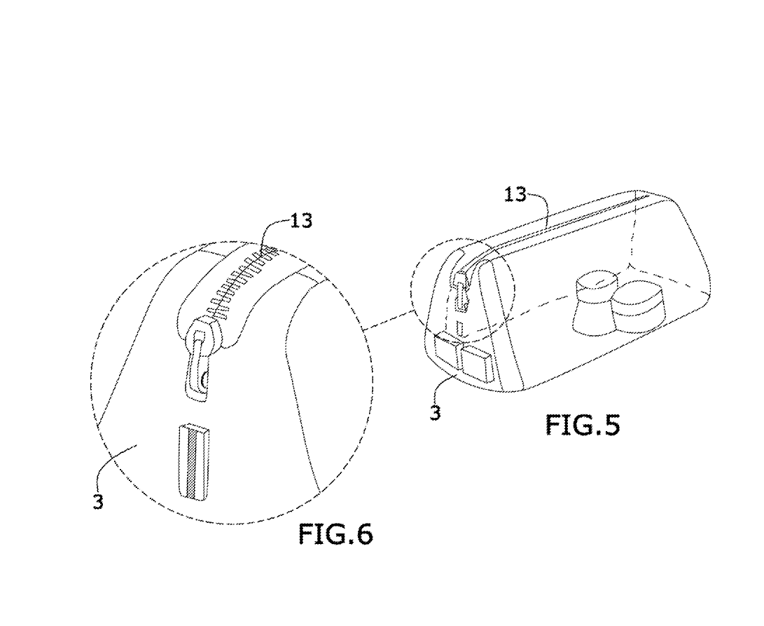

The container or box (1) may have different designs; in one possible embodiment it may be a rigid case, such as the one shown in FIGS. 3 and 4, or a flexible bag, such as the one shown in FIGS. 5 and 6.

The means for accessing the inside, in the case of being a rigid case, are a lid (2), while in the case of being a flexible bag, they are a zip (13) or similar.

The opening and closing means comprise:
an electromechanical lock (4), which in a possible embodiment may be motorised.
an electronic control (5) for opening and closing
at least one biometric reader (6), preferably for fingerprints
signalling means of the operations carried out, which may be light (7) or acoustic means such as a buzzer (8)
an opening and closing detection sensor (9)
wireless communication means (10), to be able to connect with the smartphone (12) via Bluetooth for example
power supply means, which may be a number of batteries (11)
a mechanical mechanism that enables automatic locking by merely closing the box without requiring any additional action.

The electronic control is responsible for receiving information from the at least biometric sensor via fingerprints, from the opening and locking sensor, and from the wireless communication means. Furthermore, it is responsible for governing the operation of the different elements that are activated and deactivated, such as the activation of the electromechanical lock, the activation and shut-down of the visual and acoustic signalling means and sending information to the mobile phone.

The representation of the arrangement of the elements that form part of the opening and closing means do not have to be limited to the shape represented, potentially being of any shape that serves the purpose proposed.

FIGS. 3 and 4 show a rigid case as an embodiment of the container or box in which the details of the opening and closing means may be seen, based on blocking and freeing the pull tab of the opening and closing of a zip.

Firstly, the start-up system thereof must be configured, the application having to be first downloaded onto the smartphone, then the phone must be paired with the container or box in order to then register the different users.

Having thus adequately described the nature of the present invention, as well as how to put it into practice, it must be noted that, within its essential nature, the invention may be carried out according to other embodiments differing in detail from that set out by way of example, which the protection sought would equally cover, provided that the fundamental principle thereof is not altered, changed or modified.

1. A system for transporting and housing cosmetics comprising:
a container or box provided with means for accessing the inside and means for opening and closing the container or box,
a smartphone that may send and receive information to and from the container or box,
wherein:
the opening and closing means are based on the use of biometric sensors for reading fingerprints, and
the smartphone enables the registration and de-registration of users to be controlled and remote opening and closing to be carried out.

2. The system for transporting and housing cosmetics, according to claim 1, wherein the container or box is a rigid case that is accessed through a lid.

3. The system for transporting and housing cosmetics, according to claim 1, wherein the container or box is a flexible bag that is accessed via a zip.

4. The system for transporting and housing cosmetics, according to claim 1, wherein the opening and closing means, in addition to the at least one biometric sensor for reading fingerprints, comprises:
an electromechanical lock,
an electronic control for opening and closing,
signalling means of the operations carried out, which may be light or acoustic means such as a buzzer,
an opening and closing detection sensor,
wireless communication means, to be able to connect with the smartphone via Bluetooth for example,
power supply means,
an electronic registering mechanism of opening and alarm events, and
a mechanical mechanism that enables automatic locking by merely closing the box without requiring any additional action.

5. The system for transporting and housing cosmetics, according to claim 4, wherein the electromechanical means for opening and closing are motorized.

6. The system for transporting and housing cosmetics, according to claim 4, wherein the power supply means are a number of batteries.

7. The system for transporting and housing cosmetics, according to claim 1, wherein the container or box comprises cooling and control means, carried out via thermoelectric cooling that uses the Peltier effect and the smartphone that configures the control of the inside temperature of the box.
